(19) United States
(12) Patent Application Publication
(10) Pub. No.: US 2010/0227962 A1
(43) Pub. Date: Sep. 9, 2010

(54) THERMOPLASTIC POLYAMIDE COMPOSITIONS HAVING ENHANCED MELT FLOW INDICES

(76) Inventors: Caroll Vergelati, Sainte-baudille-de-la-tour (FR); Florence Clement, Yzeron (FR); Nicolangelo Peduto, Milano (IT); Olivier Andres, Mions (FR)

Correspondence Address: BUCHANAN, INGERSOLL & ROONEY PC, POST OFFICE BOX 1404, ALEXANDRIA, VA, 22313-1404, US

(21) Appl. No.: 12/678,310

(22) PCT Filed: Sep. 17, 2008
(86) PCT No.: PCT/EP2008/062350

§ 371 Date: May 25, 2010

(30) Foreign Application Priority Data
Sep. 18, 2007 (FR) 0706549

(51) Int. Cl. C08K 3/34; C08L 77/00

(52) U.S. Cl. 524/447; 525/429; 524/538; 524/445; 524/449; 524/456; 524/451; 525/132

(57) ABSTRACT

Novolac resins are incorporated into thermoplastic polyamide compositions for increasing the melt flow index thereof; such compositions containing the novolac resins are useful for the manufacture of plastic shaped articles, in particular by injection molding.

The present invention relates to the use of a novolac resin for increasing the melt flow index of a polyamide composition. The invention also relates to a polyamide composition comprising novolac resin and to its use for the manufacture of plastic articles, especially by injection molding.

### PRIOR ART

Polyamide-based thermoplastic compositions are raw materials that can be transformed into plastic components, especially by injection molding.

There are at least three major properties that it is desired to obtain for these polyamide-based compositions, especially when they are used in these transformation processes.

The first of these properties lies in the fact that these thermoplastic compositions used must be characterized, in the melt state, by a flow index or rheological behavior that are compatible with the forming processes of interest, such as injection molding. Specifically, these thermoplastic compositions must be sufficiently fluid when they are molten, so as to be able to be conveyed and handled easily and quickly in certain forming devices, for instance injection molding devices. It is also sought to increase the mechanical properties of these compositions. These mechanical properties are especially the impact strength, the flexural or tensile modulus, and the flexural or tensile breaking stress, inter alia. Reinforcing fillers such as glass fibers are generally used for this purpose. Finally, in the case of components molded from these thermoplastic compositions, a clean and uniform surface aspect is sought. This constraint becomes a difficult problem to solve particularly when use is made of a thermoplastic composition highly charged with glass fibers, since these glass fibers impair the surface aspect of the molded components. To obtain an acceptable surface aspect, it is known practice to use thermoplastic compositions with a high flow index. However, this increase in fluidity results in a decrease in the mechanical properties of the articles obtained.

As a result, it is thus difficult to obtain these various properties for the same polyamide-based thermoplastic composition.

### INVENTION

The Applicant has discovered, entirely surprisingly, that the use of a novolac resin makes it possible to increase the melt flow index of a polyamide composition, especially without deteriorating the mechanical properties. An optimum compromise between the flow index, the surface aspect and the mechanical properties is especially obtained when the polyamide composition comprises from 1% to 15% by weight of novolac resin relative to the total weight of the composition.

It is known practice from the prior art to use a novolac resin for providing dimensional stability to a polyamide composition, especially while avoiding water uptake of said polyamide. However, it has never been demonstrated that a novolac resin can play a role in the melt rheology of a polyamide composition. Quite to the contrary, this effect is entirely surprising in the light of what was known about novolac resins. Specifically, novolac resin is known to have an anti-plasticizing effect on polyamide in the solid state, thus tending to rigidify the structure of said polymer, and consequently suggesting a viscosity-increasing effect on the polyamide. However, it is exactly the opposite that is observed. Specifically, novolac resin makes it possible to increase the melt flow index of the polyamide, thus combining a fluidizing effect in the melt state with an anti-plasticizing effect in the solid state, while at the same time having no influence on the molecular mass of the polyamide.

The main subject of the present invention is the use of a novolac resin for increasing the melt flow index of a polyamide composition.

A particularly significant increase in the melt flow index of a polyamide composition comprising a novolac resin is especially observed when said composition is subjected to a shear of between 100 and 5000 s⁻¹.

The polyamide composition according to the invention comprising at least one novolac resin preferentially has a viscosity index VI of greater than or equal to 100 ml/g and more preferentially greater than or equal to 120 ml/g, according to standard ISO 307.

As polyamides that may be used according to the invention, mention may be made of semicrystalline or amorphous polyamides and copolyamides, such as aliphatic polyamides, semiaromatic polyamides and, more generally, linear polyamides obtained by polycondensation between a saturated aliphatic or aromatic diacid and a saturated aliphatic or aromatic primary diamine, polyamides obtained by condensation of a lactam or an amino acid, or linear polyamides obtained by condensation of a mixture of these various monomers. More specifically, these polyamides may be, for example, polyhexamethyleneadipamide, polyphthalamides obtained from terephthalic and/or isophthalic acid, and copolyamides obtained from adipic acid, hexamethylenediamine and caprolactam.

According to one preferential embodiment of the invention, the thermoplastic matrix is a polyamide chosen from the group comprising polyamide 6, polyamide 66, polyamide 6.10, polyamide 11, polyamide 12, polyamide 6.12, poly(meta-xylylenediamine) (MXD6), polyamide 66/6T, polyamide 66/6I, and blends and copolyamides, for instance copolyamide 6.66.

The composition of the invention may also comprise copolyamides derived especially from the above polyamides, or mixtures of these polyamides or copolyamides.

The preferred polyamides are polyhexamethylene-adipamide, polycaprolactam, or copolymers and blends between polyhexamethyleneadipamide and polycaprolactam.

Polyamides whose molecular weights are suited to injection-molding processes, for example with a viscosity index VI of between 100 and 160 ml/g, according to standard ISO 307, are generally used; however, polyamides of lower viscosity may also be used.

The polyamide matrix may especially be a polymer comprising star or H macromolecular chains and, where appropriate, linear macromolecular chains. Polymers comprising such star or H macromolecular chains are described, for example, in documents FR 2 743 077, FR 2 779 730, U.S. Pat. No. 5,959,069, EP 0 632 703, EP 0 682 057 and EP 0 832 149.

According to another particular variant of the invention, the polyamide matrix of the invention may be a polymer of random tree type, preferably a copolyamide having a random tree structure. These copolyamides of random tree structure and the process for obtaining them are described especially in document WO 99/03909. The matrix of the invention may also be a composition comprising a linear thermoplastic polymer and a star, H and/or tree thermoplastic polymer as described above. The matrix of the invention may also comprise a hyperbranched copolyamide of the type described in document WO 00/68298. The composition of the invention may also comprise any combination of linear, star, H, tree hyperbranched copolyamide thermoplastic polymer as described above.

The composition according to the invention preferentially contains from 40% to 80% by weight of polyamide relative to the total weight of the composition.

Novolac resins are generally compounds of polyhydroxyphenol type, for example products of condensation of phenolic compounds with aldehydes. These condensation reactions are generally catalyzed with an acid.

The phenolic compounds may be chosen, alone or as a mixture, from phenol, cresol, xylenol, naphthol, alkylphenols, for instance butylphenol, tert-butylphenol or isooctylphenol; or any other substituted phenol. The aldehyde most frequently used is formaldehyde. However, others may be used, such as acetaldehyde, para-formaldehyde, butyraldehyde, crotonaldehyde or glyoxal.

According to one particular embodiment of the invention, the resin is a product of condensation of phenol and formaldehyde.

The generic molecular structure of phenol-formaldehyde resin is especially as follows:

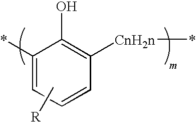

in which:
R may be a hydrogen atom or a hydrocarbon-based group,
n is between 1 and 3,
m is between 2 and 15 and preferentially between 2 and 10.

The novolac resins used advantageously have an upper molecular weight of between 500 and 3000 g/mol and preferably between 800 and 2000 g/mol.

Commercial novolac resins that may especially be mentioned include the commercial products Durez®, Vulkadur® and Rhenosin®.

The composition according to the invention may comprise between 1% and 15% by weight and especially from 2% to 10% by weight of novolac resin relative to the total weight of the composition. The polyamide composition may comprise from 1% to 25% by weight of novolac resin relative to the weight of the polyamide.

The polyamide composition according to the invention comprising novolac resin is especially used as matrix, especially for obtaining molded articles.

To improve the mechanical properties of a polyamide composition according to the invention, it may be advantageous to add thereto at least one reinforcing and/or bulking filler preferentially chosen from the group comprising fibrous fillers such as glass fibers, carbon fibers and aramid fibers, non-fibrous mineral fillers such as clays, kaolin, mica, wollastonite, silica, talc or nanoparticles. The level of incorporation of reinforcing and/or bulking filler is in accordance with the standards in the field of composite materials. It may be, for example, an amount of filler of from 1% to 80%, preferably from 10% to 70% and especially between 30% and 60%.

The polyamide composition may also comprise one or more other polymers, preferably thermoplastic polymers such as polyamide, polyolefins, ABS or polyester.

The composition according to the invention may also comprise additives usually used for the manufacture of polyamide compositions intended to be molded. Thus, mention may be made of lubricants, flame retardants, plasticizers, nucleating agents, catalysts, resilience improvers, for instance optionally grafted elastomers, light and/or heat stabilizers, antioxidants, antistatic agents, colorants, pigments, matting agents, molding agents or other conventional additives.

Plasticizers that may be mentioned include those chosen from benzenesulfonamide derivatives, such as n-butyl-benzenesulfonamide (BBSA), ethyltoluenesulfonamide or N-cyclohexyltoluenesulfonamide; hydroxybenzoic acid esters, such as 2-ethylhexyl para-hydroxybenzoate and 2-hexyldecyl para-hydroxybenzoate, tetrahydrofurfuryl alcohol esters or ethers and citric acid or hydroxymalonic acid esters. The composition may comprise from 5% to 15% by weight of plasticizer relative to the total weight of the composition.

For the preparation of a polyamide composition, these fillers and additives may be added to the polyamide via conventional means suited to each filler or additive, for instance during the polymerization or as a molten mixture. The novolac resin is preferentially added to the polyamide as a melt, especially during a step of extrusion of the polyamide, or as a solid in a mechanical mixer; the solid mixture may then be melted, for example via an extrusion process.

The polyamide composition comprising the novolac resin may also be used, as an additive, especially for imparting certain properties, especially rheological properties, to compositions comprising as matrix a thermoplastic polymer, especially a (co)polyamide. The invention thus relates to a process for manufacturing a composition in which a polyamide composition comprising novolac resin is mixed, without heating or as a melt, with a thermoplastic composition, especially based on (co)polyamide. The cold mixture may then be melted, for example via an extrusion process.

The polyamide composition comprising the novolac resin may also comprise a large proportion of additives and may be used, for example, as a masterbatch intended to be mixed with another thermoplastic composition, especially based on polyamide.

The compositions according to the invention may be used as raw material in the field of plastics processing, for example for the preparation of articles obtained by injection molding, by injection/blow-molding, by extrusion or by extrusion/blow-molding. According to a common embodiment, the modified polyamide is extruded in the form of rods, for example in a twin-screw extrusion device, which are then chopped into granules. The molded components are then prepared by melting the granules produced above and feeding the molten composition into injection-molding devices.

Specific language is used in the description so as to facilitate the understanding of the principle of the invention. It should, however, be understood that no limitation of the scope of the invention is envisioned by the use of this specific language. Modifications, improvements and perfections may especially be envisioned by a person skilled in the art of the technical field concerned on the basis of his general knowledge.

The term “and/or” includes the meanings “and”, “or” and also all the other possible combinations of the elements connected to this term.

Other details and advantages of the invention will emerge more clearly in the light of the examples below, which are given purely for indicative purposes.

### EXPERIMENTAL SECTION

### Example 1

Compositions based on polyamide (PA 66 A2700 from the company Rhodia, having a VI of 138 ml/g according to standard ISO 307), are obtained by extrusion on a ZSK40 twin-screw extruder, adding 30% by weight of glass fibers relative to the total weight of the composition, and variable amounts of novolac resin (Rhenosin PR 95 from the company Rhein Chemie), relative to the total weight of the composition.

The operating characteristics are as follows:

Twin-screw extruder: W&P ZSK40, with
temperature profile: 260-265-265-270-280° C.
screw speed (rpm): 280
motor torque (N/m): 35
vacuum: −0.9 bar

Specimens are prepared by injection molding in the following manner:

50 tonne DEMAG press, 35 mm screw
T (° C.) sheath: from 250 to 270
T (° C.) mold: 80
injection speed (cc/s): 40
injection pressure (bar): 150
maintenance pressure (bar): 40
counterpressure (bar): 15
screw speed (rpm): 160

Various properties are measured and mentioned in Table 1:

TABLE 1

| Sample | C1 | 1 | 2 | 3 | 4 |
|---|---|---|---|---|---|
| Proportion of novolac resin (%) | 0 | 4.2 | 5.6 | 7 | 8.4 |
| Spiral length (mm) | 392 | 419 | 442 | 467 | 496 |
| Notched Charpy impact (kJ/m²) | 10.8 | 11.5 | 10.5 | 10.2 | 10.4 |

The spiral length is measured according to the spiral flow test: the averages of the lengths are determined on 30 parts, after rating the system on about 100 parts. The test was performed at a sheath temperature of 280° C. and a mold temperature of 80° C., and with an injection pressure of 1500 bar. During this test, the shear rate that the product experiences at the injection threshold is from about 1000 to 3000 s⁻¹, depending on the viscosity of the product. The aim of this test is to be able to compare, for the same injected volume and the same injection pressure, at preset sheath and mold temperatures, the flow index of the various products. This difference is quantified by the length of the molded spirals. The more fluid the product, the longer the spiral length.

The notched Charpy impact strength is measured according to standard ISO 179/1eA.

A significant increase in the spiral length is thus observed for polyamide compositions comprising increasing proportions of novolac resin, while at the same time avoiding manifest degradation of the impact strength of said compositions.

### Example 2

Compositions based on polyamide (PA 66 A2700 or PA 66 A2300, of lower melt viscosity, from the company Rhodia) are obtained by extrusion on a ZSK40 twin-screw extruder, adding 10% by weight of plasticizer BBSA and 20% by weight of EPDM-g-MA, and variable amounts of novolac resin (Rhenosin PR 95 from the company Rhein Chemie), relative to the total weight of the composition.

Various properties are measured and mentioned in Table 2:

TABLE 2

Sample

| | C2 | 5 | 6 | 7 |
|---|---|---|---|---|
| PA 66 A2300 (%) | 65.0 | — | — | — |
| PA 66 A2700 (%) | — | 61.5 | 58.0 | 55.0 |
| Novolac resin (%) | — | 3.5 | 7.0 | 10.0 |
| Spiral length (mm) | 395 | 420 | 440 | 445 |

It is observed that the addition of novolac resin makes it possible to obtain polyamide compositions with a high melt flow index, even in comparison with a polyamide composition not comprising any novolac resin but a polyamide of lower melt viscosity.

1.-8. (canceled)

9. A thermoplastic polyamide composition having enhanced melt flow index when subjected to a shear of from 100 to 5,000 s⁻¹, comprising from 1% to 15% by weight of at least one novolac resin.

10. The thermoplastic polyamide composition as defined by claim 9, comprising at least one polyamide selected from the group consisting of polyamide 6, polyamide 66, polyamide 6.10, polyamide 11, polyamide 12, polyamide 6.12, poly(meta-xylylenediamine) (MXD6), polyamide 66/6T and polyamide 66/6I, and blends and copolyamides thereof.

11. The thermoplastic polyamide composition as defined by claim 9, said at least one polyamide having a viscosity index VI of from 100 to 160 ml/g, according to standard ISO 307.

12. The thermoplastic polyamide composition as defined by claim 9, said at least one novolac resin comprising a product of condensation of a phenol and an aldehyde.

13. The thermoplastic polyamide composition as defined by claim 9, comprising from 2% to 10% by weight of said at least one novolac resin.

14. The thermoplastic polyamide composition as defined by claim 9, further comprising at least one reinforcing and/or bulking filler.

15. The thermoplastic polyamide composition as defined by claim 14, comprising at least one reinforcing and/or bulking filler selected from the group consisting of glass fibers, carbon fibers, aramid fibers, clays, kaolin, mica, wollastonite, silica, talc and nanoparticles.

16. The thermoplastic polyamide composition as defined by claim 9, further comprising at least one plasticizer.

17. The thermoplastic polyamide composition as defined by claim 12, said at least one novolac resin comprising a product of condensation of phenol and formaldehyde.

18. The thermoplastic polyamide composition as defined by claim 9, further comprising another polyamide, a polyolefin, ABS, and/or a polyester.

19. A masterbatch comprising the thermoplastic polyamide composition as defined by claim 9.

20. A plastic article shaped from the thermoplastic polyamide composition as defined by claim 9.

21. A method for increasing the melt flow index of a thermoplastic polyamide composition, comprising formulating therein a melt flow index enhancing amount of at least one novolac resin.

22. A method for increasing the melt flow index of a thermoplastic polyamide composition without deteriorating the mechanical properties thereof, comprising formulating therein a melt flow index enhancing amount of at least one novolac resin.
